(19) United States
(12) Patent Application Publication
(10) Pub. No.: US 2012/0135783 A1
(43) Pub. Date: May 31, 2012

(54) MOBILE DEVICE IMAGE FEEDBACK

(75) Inventor: Jason Sams, San Jose, CA (US)

(73) Assignee: Google Inc., Mountain View, CA (US)

(21) Appl. No.: 12/955,577

(22) Filed: Nov. 29, 2010

(51) Int. Cl. G06T 1/00; H04W 88/02

(52) U.S. Cl. 455/556.1; 345/501; 348/222.1

(57) ABSTRACT

This disclosure is directed to improving a user experience when operating a mobile device that includes a display. In one example, a mobile device is configured to render an image via a display of the mobile device. The image includes one or more properties. The mobile device may identify, using one or more sensors, one or more characteristics of a relationship between the mobile device and an optical environment of the mobile device. One or more indications of the identified characteristics may be provided to a graphics processing pipeline of the mobile device configured to present images via the display. The graphics processing pipeline may modify the one or more properties of the image to reflect the identified characteristic.

### TECHNICAL FIELD

This disclosure relates to the display of images via a mobile device.

### BACKGROUND

Multi-functional mobile devices, for example smart phones and tablet computers, have become increasingly popular with many consumers. Many such multi-functional devices include a display and any combination of hardware and/or software configured to control the presentation of images via the display. In some examples, a multi-functional device may include a graphics processing pipeline that includes hardware, software, or any combination of hardware and software to process images for presentation to a user.

Multi-functional mobile devices may further incorporate a variety of detection elements, e.g., sensors, to detect user input. For example, multi-functional mobile devices may include one or more accelerometers, gyroscopes, camera elements, ambient light sensors, and the like to detect various user input. An accelerometer may detect device movement in space. A gyroscope may detect device orientation is space with respect to the ground. A camera element may capture images of a device's surroundings as directed by a user. An ambient light sensor may detect a level of ambient light in an optical environment of the device.

### SUMMARY

The instant disclosure is generally directed to techniques for improving a user experience when operating a mobile device. A mobile device may be configured to present images via a display of the device. One or more device sensors may be configured to detect characteristics of the device with respect to an optical environment of the device and correspondingly cause one or more images presented via the device display to be modified to reflect the optical environment. A user experience may be improved according to the techniques of this disclosure, because images presented via a mobile device display may appear more lifelike and animated. The techniques of this disclosure may further be used as an input mechanism for the detection of user input.

In one example, a method is described herein. The method includes rendering, by a graphics processing pipeline of a mobile device, an image presented by a display of the mobile device, wherein the image includes one or more properties. The method further includes identifying, using at least one sensor of the mobile device, a characteristic of a relationship between the mobile device and an optical environment of the mobile device. The method further includes providing, to the graphics processing pipeline, at least one indication of the characteristic of the relationship between the mobile device and the optical environment. The method further includes modifying, by the graphics processing pipeline, the one or more properties of the image presented on the display to reflect the characteristic of the relationship between the mobile device and the optical environment of the mobile device.

According to another example, a mobile device is described herein. The mobile device includes a graphics processing pipeline configured to render an image at a display of the mobile device, wherein the image includes one or more properties. The mobile device further includes a sensor processing module configured to receive, from at least one sensor communicatively coupled to the mobile device, a characteristic of a relationship between the mobile device and an optical environment of the mobile device and provide, to the graphics processing pipeline, at least one indication of the at least one characteristic of the relationship between the mobile device and the optical environment of the mobile device. The mobile device further includes means for modifying the one or more properties of the image to reflect the at least one characteristic of the relationship between the mobile device and the optical environment of the mobile device.

According to another example, an article of manufacture comprising a computer-readable medium that stores instructions is described herein. The instructions are configured to cause a mobile device to render, by a graphics processing pipeline of the mobile device, an image presented by a display of the mobile device, wherein the image includes one or more properties. The instructions further cause the mobile device to identify, using at least one sensor of the mobile device, a characteristic of a relationship between the mobile device and an optical environment of the mobile device. The instructions further cause the mobile device to provide, to the graphics processing pipeline, at least one indication of the at least one characteristic of the relationship between the mobile device and the optical environment. The instructions further cause the mobile device to modify, by the graphics processing pipeline, the one or more properties of the image to reflect the at least one characteristic of the relationship between the mobile device and the optical environment of the mobile device.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating one example of a device configured to operate according to one or more techniques of this disclosure.

FIG. 2 is a block diagram illustrating one example of various components of a device configured to operate according to one or more techniques of this disclosure.

FIG. 3 is a conceptual diagram illustrating one example of a device configured to operate according to one or more techniques of this disclosure.

FIG. 4 is a conceptual diagram that illustrates one example of a user input mechanism for a device consistent with one or more techniques of this disclosure.

FIG. 5 is a flowchart illustrating one example of a method of providing feedback to a device image consistent with one or more techniques of this disclosure.

FIG. 6 is a conceptual diagram illustrating one example of a device configured to operate according to one or more techniques of this disclosure.

### DETAILED DESCRIPTION

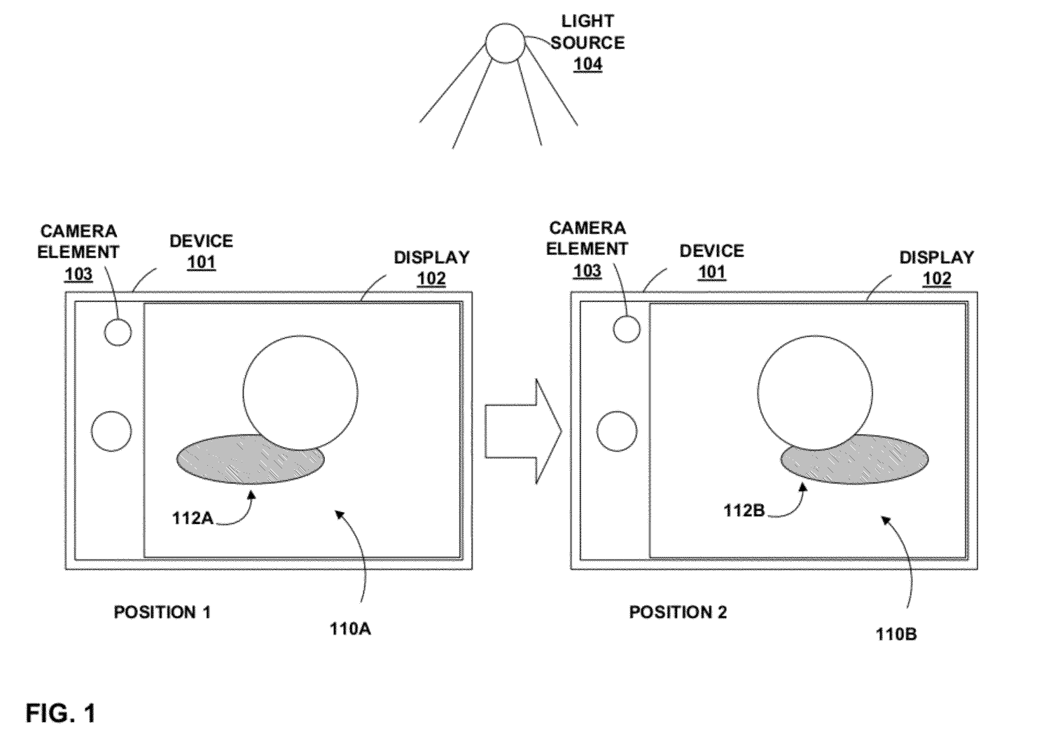

FIG. 1 is a conceptual diagram that illustrates one example of a mobile device 101 configured to operate according to one or more techniques of this disclosure. A shown in FIG. 1, mobile device 101 includes a display 102. Mobile device 101 may be configured to present a variety of images to a user via display 102. For example, mobile device 101 may include any combination of hardware, software, or the like configured to control display 102 for the presentation of images. In one non-limiting example, device 101 may include a graphics pipeline for the presentation of images via display 102. Images presented via display 102 may include any combination of video images, still images, two-dimensional (2D) images, and/or three-dimensional (3D) images.

Mobile device 101 may be configured to present some images via display 102 that include features dependent in part on a relationship between the subject of the image and a virtual environment in which the subject of the image is disposed. One example of an image 112A that includes a feature dependent on a virtual optical environment is illustrated in FIG. 1. Image 112A depicts a ball. The ball is shown with a shadow that extends to the left of the ball. The shadow of image 112A may be considered a property of image 112A dependant on a virtual optical environment. As shown in FIG. 1, the shadow of image 112A is shown extending to the left of the ball. Image 112A is at least somewhat dependent on a virtual optical environment, (e.g., perspective) in the sense that, for a real-world object (e.g., a ball), if a position of a light source illuminating the ball, or the ball with respect to the light source, were to change (e.g., from being above the ball to the right, to being above the ball to the left), the shadow of image 112A would change to extend in the opposite direction (e.g., to the right).

For typical mobile devices, an image such as image 112A would maintain its relationship with respect to a virtual light source (e.g., the light source “illuminating” the ball of image 112A from the upper right), regardless of an optical environment of the mobile device 101. For example, if one were to view image 112A on a mobile device, and move from outdoors on a sunny day to an indoor area with little or no light, the image presented via the display will remain the same with respect to the virtual light source, e.g., the shadow of FIG. 1 image 112A of a ball would remain to the left and of the same size and shape, even if mobile device 101 is not experiencing any external light source at all.

FIG. 1 shows one example of a mobile device 101 configured to operate consistent with one or more techniques of this disclosure. As shown in FIG. 1, mobile device 101 is configured to present an image 112A via a display 102 of device 101. The image 112A includes at least one environment-dependent feature, or characteristic, as described above. In the example of FIG. 1, mobile device 101 may detect characteristics of an optical environment of the mobile device. FIG. 1 shows mobile device 101 illuminated by a single light source 104 arranged above and to the right of mobile device 101.

Mobile device 101 may include one or more sensors. For example, mobile device may include one or more camera elements (image capture device(s)), ambient light sensors, accelerometers, gyroscopes, or the like. In the example of FIG. 1, mobile device 101 includes a camera element 103 presented at a display 102 surface of device 101. In other examples not depicted in FIG. 1, mobile device 101 may further or instead include one or more back or side surface camera elements.

Mobile device 101 may utilize one or more sensors to determine or identify characteristics of a relationship between device 101 and an optical environment of device 101 (e.g., light source 104). In some non-limiting examples, mobile device 101 may detect one or more characteristics of an optical environment such as a position of device 101 with respect to one or more sources of light (e.g., light source 104), an orientation of device 101 with respect to one or more sources of light, an intensity of light detected from one or more light sources, and/or a color, (wavelength) of detected light. In response to detection of optical environment characteristics, device 101 may present an image (e.g., image 112A) via display 102 consistent with the detected optical environment characteristic.

For example, according to FIG. 1, at position 1 device 101 is positioned below and to the left of light source 104. In response to device 101 detection of a position of light source 104 with respect to device 101, device 101 may cause image 112A to be presented via display 102 with at least one feature that reflects the optical environment (e.g., a position of light source 104) of device 101. For example, at position 1 in FIG. 1, the shadow extending from the ball of image 112A is shown extending to the left, consistent with the relationship of mobile device 101 (in position 1) with respect to an optical environment of the device (e.g., light source 104).

Device 101 may further be configured to detect changes in a relationship between device 101 and an optical environment of device 101. For example, as shown in the FIG. 1 example, device 101 is depicted at a first position (position 1) at the left of FIG. 1, with light source 104 arranged above and to the right of device 101. Device 101 is shown presenting image 103 via display 102. As indicated by the arrow in FIG. 1, device 101 may be moved to a second position (position 2) with respect to light source 104 (or light source 104 is moved with respect to device 101). One or more sensors of device 101 (e.g., camera element 103) may be configured to detect that a relationship between device 101 and an optical environment of device 101 has changed. For example, as shown in FIG. 1, a position of device 101 with respect to light source 104 has changed (from position 1 to position 2) such that device 101 is now illuminated from above and to the left.

As also shown in FIG. 1, device 101 may, when moved from position 1 to the position 2, modify image 110A and present a modified version 110B of image 110A via display 102 in response to the detected change in the relationship between device 101 and the optical environment of device 101 (e.g., light source 104). In the example of FIG. 1, modified image 110B includes a shadow 112B that extends to the right, consistent with the position of device 101 at position 2.

The example depicted in FIG. 1 is merely one non-limiting example of a mobile device 101 configured to provide optical environmental feedback for presentation of an image via a display 102. For example, a device 101 may detect various characteristics of a device optical environment such as the position of one or more light sources with respect to device 101, an orientation of device 101 with respect to one or more light sources, an intensity of detected lights, and/or a color (wavelength) of detected light. Other characteristics of a relationship between a device 101 and an optical environment of device 101 may also be detected and are consistent with the techniques of this disclosure.

Furthermore, FIG. 1 depicts an example of presenting, or modifying, a virtual optical environment dependent feature of an image presented via a device display consistent with device 101 detection of an optical environment characteristic of the device. For example, in addition to modification of shadowing of an image of an image object presented via display 102 as shown in FIG. 1, device 101 may further or instead present and/or modify other environmentally dependent features such as texture, virtual illumination source positioning, color, consistency, and like features.

FIG. 1 shows one example in which device 101 is configured to present or modify presentation of an image 112A that directly corresponds to a detected optical environment characteristic of device 101, e.g., a position of device 101 has changed, and a shadow of image 112A is modified to present image 112B similar to a shadow change that would result from a similar position change of a real-world object. In other examples not depicted in FIG. 1, device 101 may present or modify presentation of an image 112B that does not directly correspond to an associate characteristic that would occur for a real-world object in response to an optical environment characteristic.

For example, device 101 positioning depicted in FIG. 1 may cause device 101 to present or modify a color, texture, size, or other characteristic in response to the detected optical environment characteristic of device 101. Other examples of image changes in response to detected device optical environment characteristics are also contemplated and consistent with this disclosure.

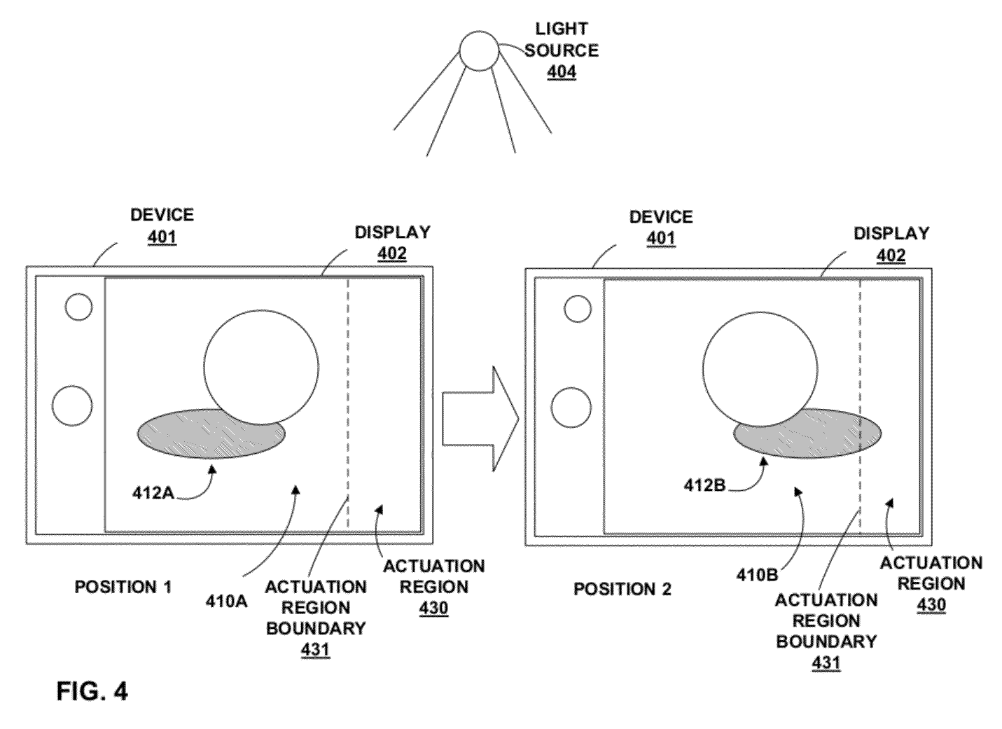

The techniques of this disclosure may provide for a generally improved user experience when operating a mobile device 101. For example, images presented or modified according to the techniques of this disclosure may appear more lifelike and/or fun for a user. In addition, a device operated according to the techniques of this disclosure may provide for additional input mechanisms for detection of user input, as described in further detail below with respect to FIG. 4.

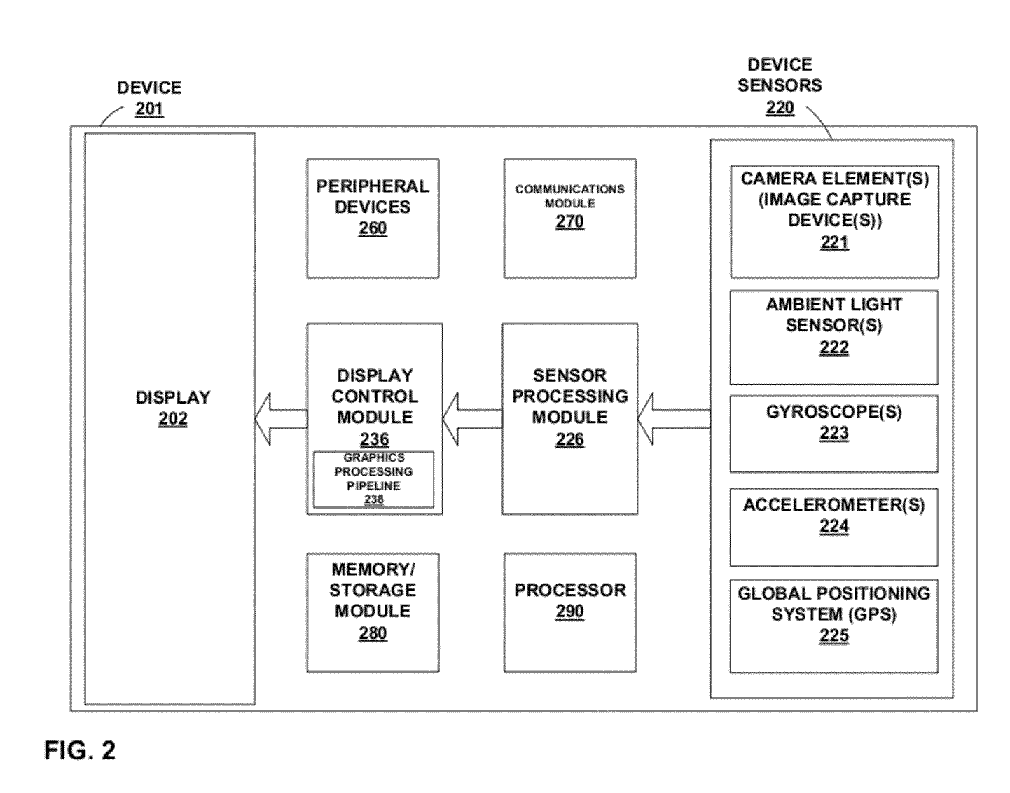

FIG. 2 is a block diagram illustrating one example of various components of a mobile device 201 that may be configured to operate according to the techniques of this disclosure. As shown in FIG. 2, device 201 includes a display 202. Display 202 may include a plurality of display elements configured to, in combination, operate to present images via display 202. In some non-limiting examples, display elements of display 202 may include a plurality of light emitting diodes (LED), liquid crystal display (LCD) elements, or other elements configured to emit light of different colors, intensities, and other characteristics.

As shown in FIG. 2, device 201 may include one or more processors 290, memory/storage modules 280, communications modules 270, and peripheral devices 260. The one or more processors 290 include one or more electrical circuits configured to execute program instructions to carry out operations of device 201. For example, processor 290 may be configured to execute graphics processing software for the presentation of images presented via display 202. Processor 290 may further be configured to execute program instructions to carry out various functionality of device 201 described herein.

As also shown in FIG. 2, mobile device 201 may include one or more memory/storage modules 280. Memory/storage module 280 may include any form of short term (e.g., random access memory (RAM) or other volatile memory component), or long term (e.g., magnetic hard disc, Flash, or any other non-volatile memory component). Memory/storage module 280 may be used by processor 290 or other components of device 201 to temporarily or chronically store information. For example, memory/storage module 280 may be configured to store program instructions such as software that may be executed by processor 290 to cause detection and/or processing by one or more sensors 221 of device 201, or coupled to device 201. As also shown in FIG. 2, mobile device 201 may include one or more communications modules 270. The one or more communications modules 270 may be operative to facilitate communication via a network, e.g., a wireless (e.g., Wi-fi®, cellular, Bluetooth®) or wired (e.g., Ethernet) connection.

As also shown in FIG. 2, device 201 may be coupled to one or more peripheral devices 260. The one or more peripheral devices 260 may include various input/output mechanisms of device 201, such as a keyboard, mouse, monitor, printer, or the like. Other types of peripheral devices 260 are also contemplated. In some examples, the one or more peripheral devices 260 may include one or more additional sensors coupled to mobile device 201. For example, peripheral devices 260 may include one or more camera elements 221 (e.g., still or video camera elements), ambient light sensors 222, gyroscopes 223, accelerometers 234, or global positioning system (GPS) 225 sensors as described herein.

As shown in the example of FIG. 2, device 201 may include one or more sensor elements 221. The one or more sensor elements 221 may include any combination of camera elements 221 (still or video), ambient light sensors 222, gyroscopes 223, accelerometers 234, or global positioning system (GPS) 225 sensors. The one or more sensor elements 221 may be coupled to a sensor processing module 226. Sensor processing module 226 may be configured to receive, from the one or more sensors 221, electrical or other signals indicative of detected measurements.

For example, sensor processing module 226 may receive, from one or more camera elements 221, one or more signals indicative of images captured by camera elements 221. Sensor processing module 226 may analyze, process, and/or compare signals indicative of captured images to determine characteristics and/or changes in characteristics of an optical environment of device 201. For example, sensor processing module 226 may analyze an image to estimate and/or determine a position of a light source in a captured image.

Sensor processing module 226 may also or instead compare captured images to determine changes in an optical environment. For example, sensor processing module 226 may compare illumination in two or more captured images to determine that device 201 has changed position or orientation with respect to one or more light sources that effect an optical environment of device 201. Various other characteristics of an optical environment of device 201 may also or instead be determined, via one or more output signals from one or more of sensor elements 220, alone or in combination.

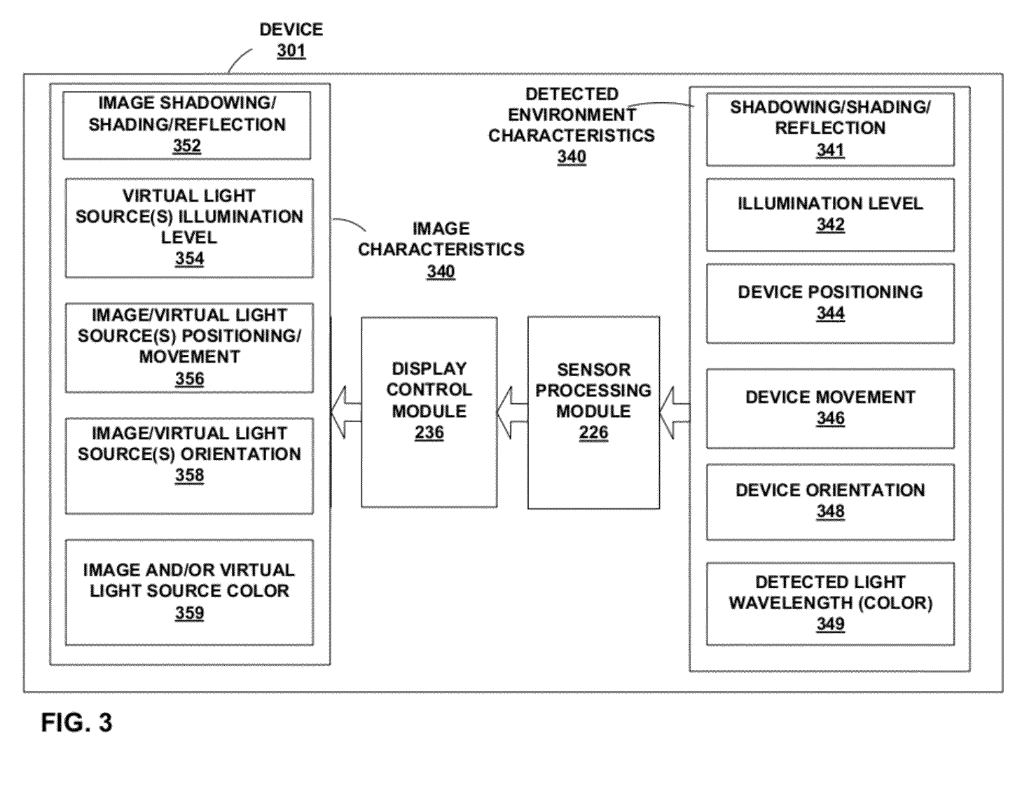

FIG. 3 is a functional block diagram that illustrates various examples of optical environment characteristics 340 that may be detected by device 301 and image characteristics 342 that may be displayed and/or modified in response to detected optical environment characteristics 340 consistent with the techniques of this disclosure. The one or more optical environment characteristics may be detected or identified by one or more sensors of device 301. The one or more device 301 sensors may include sensors 220 such as those depicted in FIG. 2 above. In one example, device 301 may be configured to detect shadowing, shading, or reflection 341 of one or more subjects (e.g., objects) of a captured image caused by an optical environment of device 301. For example, sensor processing module 226 may receive from one or more cameral elements 231 one or more indications of captured images, and process/analyze the one or more indications to determine shadowing, shading, or reflection 341 of objects in the one or more images. For example, sensor processing module 226 may determine shadowing or shading of an object of captured images to determine shadowing or shading of the object. According to another example, sensor processing module 226 may determine whether a substantially reflective object of a captured image is reflecting light, or reflecting an image of another object of the device optical environment. Determined shadowing/shading/reflection of captured image objects may provide an indication of an optical environment of device 301, for example a location of one or more light sources.

In another example, device 301 may be configured to detect an illumination level 342 of an optical environment of device 301. For example, sensor processing module 226 may receive from one or more cameral elements 231 one or more indications of captured images, and process/analyze the one or more indications to determine an illumination level 342 of the captured image(s). In other examples, sensor processing module 226 may receive one or more direct indications of illumination levels from one or more ambient light sensors 232 to determine an illumination level of an optical environment of device 301.

In another example, device 301 may be configured to detect a coloring of light of an optical environment of device 301. For example, sensor processing module 226 may receive from one or more cameral elements 231 one or more indications of captured images, and process/analyze the one or more indications to determine a color of objects of the capture images. Object coloring may indicate a color of light from one or more light sources of an optical environment of device 301.

In other examples, the one or more detected characteristics may include indirect indications of a relationship between device 201 and an optical environment of device 201. For example, sensor processing module 226 may provide display module with one or more indications of a device orientation 346 (e.g., detected via one or more gyroscopes 223) or movement (e.g., detected via one or more accelerometers 234) in space, which may indirectly indicate an orientation of device 201 with respect to an optical environment of device 201 (e.g., one or more light sources).

In another example, device 301 may be configured to detect one or more indications of device positioning 344. For example, device 301 may be configured to determine a positioning of device 301 with respect to one or more light sources. For example, sensor processing module 226 may receive from one or more camera elements 231 one or more indications of captured images, and process/analyze the one or more indications to determine a positioning of device 301 with respect to an optical environment of device 301 (e.g., positioning of one or more light sources, such as the sun, with respect to device 301).

In another example, sensor processing module 226 may receive from one or more GPS units 225 one or more indications of a geographic position of device 301. According to these examples, one or more other indications of light source positioning (e.g., via one or more camera elements 231 or ambient light sensors 232, or where the light source is the sun, a time of day) may be used in conjunction with the one or more indications of geographic position to determine a relative positioning of device 301 with respect to at least one light source of an optical environment of device 301.

In another example, device 301 may be configured to determine movement 346 of device 301 with respect to an optical environment of device 301 (e.g., with respect to one or more light sources of an optical environment of device 301). For example, sensor processing module 226 may receive one or more indications of device 301 movement from one or more accelerometers 234, gyroscopes 233, or GPS 225 to determine device 301 movement. According to these examples, movement of device 301 may indicate a position and/or orientation of device 301 with respect an optical environment of device 301, including one or more light sources.

In another example, device 301 may be configured to determine an orientation 348 of device 301 with respect to an optical environment of device 301. For example, sensor processing module 226 may receive one or more indications of device 301 orientation by processing/analysis of images captured by one or more camera elements 221. In another example, sensor processing module 226 may receive one or more indications from an accelerometer (orientation movement) or gyroscope (e.g., direct measurement of orientation) to determine an orientation of device 301 with respect to an optical environment of device 301.

Sensor processing module 226 may be configured to determine characteristics of an optical environment of device 301 based on one or more indications from the above-described sensors 220 alone or in combination. In one example, sensor processing module 226 may capture multiple images (e.g., from multiple camera elements 221, such as front and back camera elements of device 301) of an environment of device 301, and independently extract characteristics from the multiple images. According to this example, sensor processing module 226 may independently determine similar characteristics (e.g., illumination levels, shadowing, coloring) of the same or different objects of the device 301 optical environment, and determine one or more characteristics of the optical environment of device 301 based on both captured images. Determining an optical environment characteristic according to this example may improve accuracy.

In another example, sensor processing module 226 may be configured to determine optical environment characteristics based on indications from one or more other sensors in combination with photographic images captured by one or more camera elements (e.g., camera elements 221 depicted in FIG. 2). For example, an indication from a gyroscope sensor (e.g., gyroscopes 223 depicted in FIG. 2) may indicate a particular orientation in space of device 301 (e.g., that device 301 is held vertically, horizontally, or at a particular angle in space). The indication of device 301 orientation may be used in combination with a photographic image processed to determine shadowing or other characteristics indicative of device 301 orientation with respect to one or more light sources to determine an orientation of device 301 in space. Similarly, accelerometer (e.g., accelerometer 234 in the example of FIG. 2) detection of device movement, GPS (e.g., GPS 225 in the example of FIG. 2) detection of device position, or other indications from other sensors may be utilized in combination with one or more characteristics determined from one or more camera elements (e.g., camera elements 221 depicted in FIG. 2) photographic images to determine one or more characteristics of an optical environment, or changes in characteristics of the optical environment, of device 301.

In still other examples, detection of a device 301 environment may be used to trigger detection of other environment characteristics. For example, gyroscope, accelerometer, and/or GPS sensors may provide an indication that device 301 has changed position or orientation. Detection of a position/orientation change of device 301 may trigger sensor processing module 226 to operate one or more sensors (e.g., sensors 220 depicted in FIG. 2) to capture other information. For example, detection of a position/orientation change of device 301 may trigger sensor processing module 226 to cause one or more camera elements to capture one or more images of a device 301 environment. This technique may be advantageous, because device 301 may be intermittently operated to detect optical environment changes (e.g., to capture one or more photographic images), thus reducing a drain on a battery of device 301.

Referring back to FIG. 2, device 201 includes a display control module 236. Display control module 236 is generally configured to provide control signals to display 202 (e.g., to one or more display elements as discussed above), to control images presented via display 202. In some examples, display control module 236 may comprise a graphics processing pipeline. The graphics processing pipeline may include any combination of hardware, software, firmware, or the like configured to process data representing images and cause images to be presented via display. In some examples, display control module 236 may be configured to cause images with three-dimensional qualities to be presented via display 202. Display control module 236 may instead or in addition be configured to present any combination of 2D, 3D, video, or still images.

According to various techniques described herein, display control module 236 may be configured to receive, from sensor processing module 226 one or more indications of detected characteristics relevant to an optical environment of device 201, and correspondingly modify presentation of an image, e.g., properties of a still image or video, in response to the detected optical environment characteristic of device 201. In some examples, presentation (e.g., properties) of an image may be modified to reflect the same or similar optical environment characteristic detected for device 201. For example, where a detected characteristic indicates a shadow may be formed as a result of a relationship between device 201 and one or more light sources, an image may be presented with a shadow property that reflects the detected characteristic for device 201. In other examples, presentation of different properties of an image may be modified in light of a detected optical environment of device 201. For example, where a detected characteristic indicates a shadow would be formed as described above, a color, texture, light intensity, reflection or other characteristic may be modified in light of a detected device 201 optical environment characteristic.

As set forth above, sensor processing module 226 may be configured to determine optical environment characteristics and/or changes in optical environment characteristics for device 201. Display control module 236 may receive from sensor processing module 226 the one or more detected characteristics, and correspondingly cause one or more images presented via display 201 to be displayed with properties in response to the determined one or more characteristics, or change displayed image properties to reflect the determined one or more characteristics. In some examples, display control module 236 may be configured to modify shadowing, shading, texture, reflection, or other image properties based on detected optical environment characteristics.

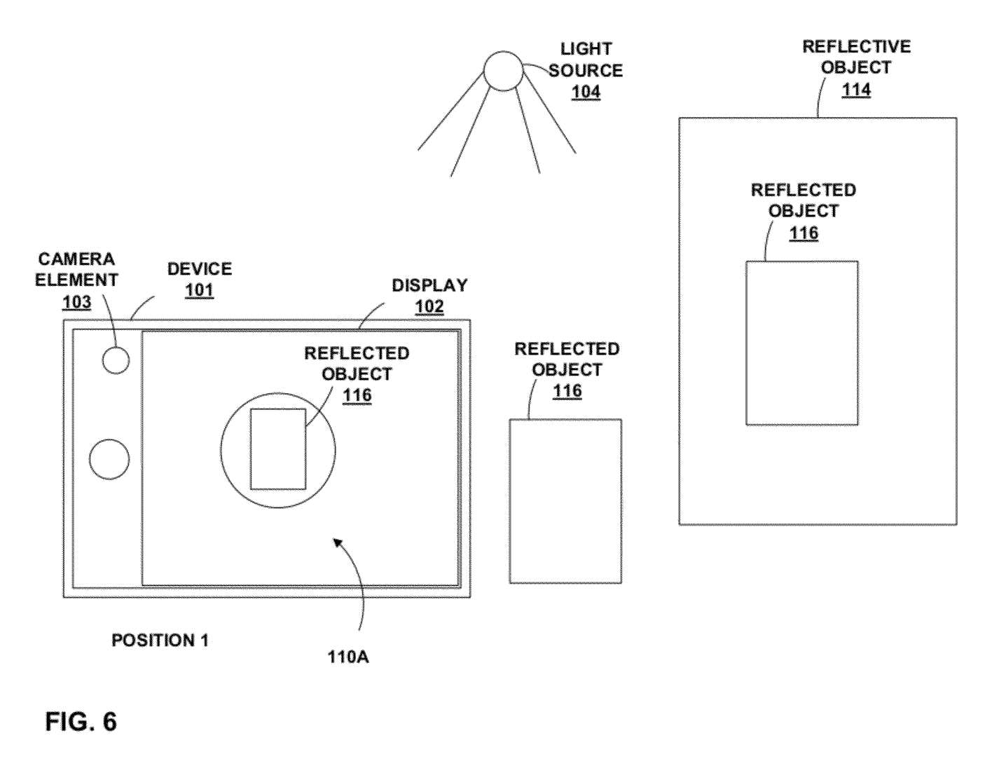

For example, where a reflective object in one or more captured images reflects another object in the device optical environment, display control module may modify a displayed image to cause the displayed image to include the captured image of the reflective object. In one example, if the device camera element captures an image of a user standing in front of a mirror that reflects an image of the user, display control module 236 may cause a displayed image to include an image of the user. FIG. 6 illustrates one such example. As shown in FIG. 6, an optical environment of device 101 includes a reflective object 114 (e.g., a mirror or other reflective surface) and a reflected object 116. From the viewpoint of device 101, reflected object 116 may be reflected in reflective object 114. Accordingly, device 101 may cause image 110A to be presented in accordance with the reflected object and/or the reflective object 114. For example, as shown in FIG. 6, image 110A is shown including reflected object 116. In another example not depicted in FIG. 6, image 110A may be presented showing reflective object 114 and/or reflected object 114. For example, where reflective object 114 is a mirror, image 110A may be presented with an image of the mirror, and/or one or more objects reflected by the mirror.

In other examples, where a detected optical environment characteristic indicates a change in position or orientation of device 201 with respect to one or more light sources, display control module 236 may correspondingly modify the presentation of shadowing, shading, texture, or reflection in a displayed image, or modify a virtual light source (e.g., a location of a virtual light source) of a displayed image. In another example, where a detected optical environment condition indicates a particular light source color (or color of image reflection) of a device 201 optical environment, a color of a displayed image (or color of reflection of the displayed image) may be modified to reflect the detected color.

As discussed above, display control module 236 may include a graphics processing pipeline 238 as well known in the relevant arts. A graphics processing pipeline 238 as described herein may include any combination of hardware, software, or firmware configured to cause images to be presented via display 202. The graphics processing pipeline 238 may accept some representation of an image, and rasterize, or render, the image based on the input. A graphics pipeline 238 may operate based on one or more graphics modeling libraries. One non-limiting example of a graphics modeling library is OpenGL® made available by Silicon Graphics, Inc. Another non-limiting example of a graphics modeling library is Direct3D® made available by Microsoft®.

A graphics processing pipeline 238 may include a plurality of stages for translating a representation of an image (e.g., code defining characteristics of a particular image) into a rendered image based on image primitives such as those of a graphics library. In one non-limiting example, a graphics processing pipeline 238 includes transformation, per-vertex lighting, viewing transformation, primitive generation, projection transformation, clipping, scan conversion or rasterization, texturing fragment shading, and display stages. According to the techniques of this disclosure, display control module 236 may be operative to affect one or more stages of a graphic processing pipeline 238 to reflect detected device optical conditions (e.g., from sensor processing module 226) as described above.

In some examples, display control module 236 may provide parameters or other information to a pre-vertex lighting stage in which geometry of an image is lit according to defined locations of light sources, reflectance, and other surface properties, such that detected changes in device optical conditions may be reflected in properties of a displayed image. In other examples, display control module 236 may provide parameters or other information to a viewing transformation stage in which objects are transformed from 3D world space coordinates into a 3D coordinate system based on the position and orientation of a virtual camera. Other stages of a graphics processing pipeline 238 may also be configured to receive information as described above to modify rendering/rasterization of an image to reflect device 201 optical environment characteristics.

FIG. 3 also depicts some examples of image modification that may be performed in light of one or more detected characteristics of an optical environment of device 301. For example, image shadowing/shading/reflection 352, illumination level of one or more virtual light sources 354, positioning/movement of one or more image objects or virtual light sources illuminating an image object 356, orientation of one or more images/virtual light sources 358, and virtual light source/image color 359, alone or in combination, may be modified in response to a detected optical environment condition of device 301. In some examples a modification of a displayed image as described herein may be associated with a corresponding detected characteristic, for example a detected orientation or position change of device 301 with respect to at least one light source may cause a shadow of an image to change. In other examples, modification may not be directly associated with an optical environment characteristic. For example, the above-described orientation change of device 301 may cause a color, texture, or other unrelated change in display of an image.

Display control module 236 and sensor processing module 226 as described herein may include any combination of hardware, software, or firmware configured to operate as described above. For example, one or more of display control module 236 and sensor processing modules 226 may include one or more program instructions (e.g., software) stored on a memory/storage module (e.g., memory/storage module 280 as depicted in FIG. 2) and executable by one or more processor (e.g., processor as depicted in FIG. 2) to perform the operations described above. One or more of display control module 236 and sensor processing module 226 may further utilize hardware in addition to one or more processors. For example, display program module 236 may utilize one or more hardware components dedicated to graphics processing, e.g., a dedicated graphics processing unit (GPU), digital signal processor (DSP), or the like. In other examples, sensor processing module 226 may utilize dedicated hardware to perform the operations described above. For example, sensor processing module 226 may utilize one or more analog to digital, digital to analog converters, or DSP modules to convert detected environmental characteristics into useable information.

FIG. 4 is a conceptual diagram that illustrates one example of using one or more techniques of this disclosure as a user input mechanism for a device 401 consistent with this disclosure. The example of FIG. 4 is similar to the example depicted in FIG. 1, where device 401 has a display 402, with an image 410A presented on display 402. Image 410A includes at least one feature 412A that is dependent on a virtual optical environment of an object (a ball) of the image. According to the techniques of this disclosure described above, device 401 may be configured to determine a characteristic of an optical environment of device 401, and correspondingly modify a property of image 410A based on the detected optical environment characteristic. For example, device 401 may be configured to determine that device 401 has changed position and/or orientation with respect to at least one light source 404.

Unlike the example of FIG. 1, in the example of FIG. 4 an actuation region 430 is presented via display. In some examples, the actuation region 430 may be visible to a user (e.g., represented via coloring, shading, or the like) via display 402. The example of FIG. 4 shows actuation region 430 represented by an actuation region boundary 431 presented via display 402. In other examples, actuation region 430 may not be visible to a user.

In the example of FIG. 4, device 401 has been moved from position 1 to the left of light source 404 to position 2 to the right of light source 404. According to the techniques of this disclosure, a shadow 412A of image 410A has been changed in response to the detected position change. Accordingly, at position 2, shadow 412A has crossed into actuation region 430.

In various examples, device 401 may be configured to utilize a change in an image optical characteristic caused by a user, such as a location of a shadow caused by a detected device optical environment characteristic (e.g., user modification of an orientation or position of device 401) as described herein, as a user input mechanism to cause one or more operations to be performed by device 401. For example, where device 401 is configured to operate a media player (e.g., a music and/or video player), a user may modify an optical environment of device 401 (e.g., a position or orientation of device 401 with respect to light source 404), to cause the music or video to be paused, skip to a subsequent track, or modify a playback volume or display intensity. Other examples are also contemplated. For example, a detected change in device optical environment characteristic may cause a device to execute a particular program, turn off or go to sleep, initiate a phone call, or operate a game.

FIG. 4 depicts one example of utilizing the techniques of this disclosure as a user input mechanism. Other examples are also contemplated. According to the example of FIG. 4, one or more actuation regions 430 may be defined via display 402. Detected changes in optical environment characteristics, for example that a user has moved device 401 with respect to at least one light source 404, may cause at least one characteristic (e.g., shadow 412A) of an image 410A to change. In the example of FIG. 4, a user has moved device 401 from a first position (position 1) to a second position (position 2) with respect to light source 404. Accordingly, shadow 412A of image 410A has moved from the left, to the right. When the user has moved device 401 to a position such that shadow 412B crosses into actuation region 430, one or more operations of device 401 may be executed. Accordingly, the detection of optical environment characteristics may be utilized as an actuation mechanism for device 401 to receive input from a user.

Other examples of device actuation in response to optical environment characteristics are also contemplated. For example, detected changes as described herein may cause various modification of an image including color, texture, image positioning, orientation, or movement. Any or all changes to an image may be used as actuation mechanisms, alone or in combination. For example, a user may match up colors of an image with colors of a second, different image to cause a device 401 operation to be performed.

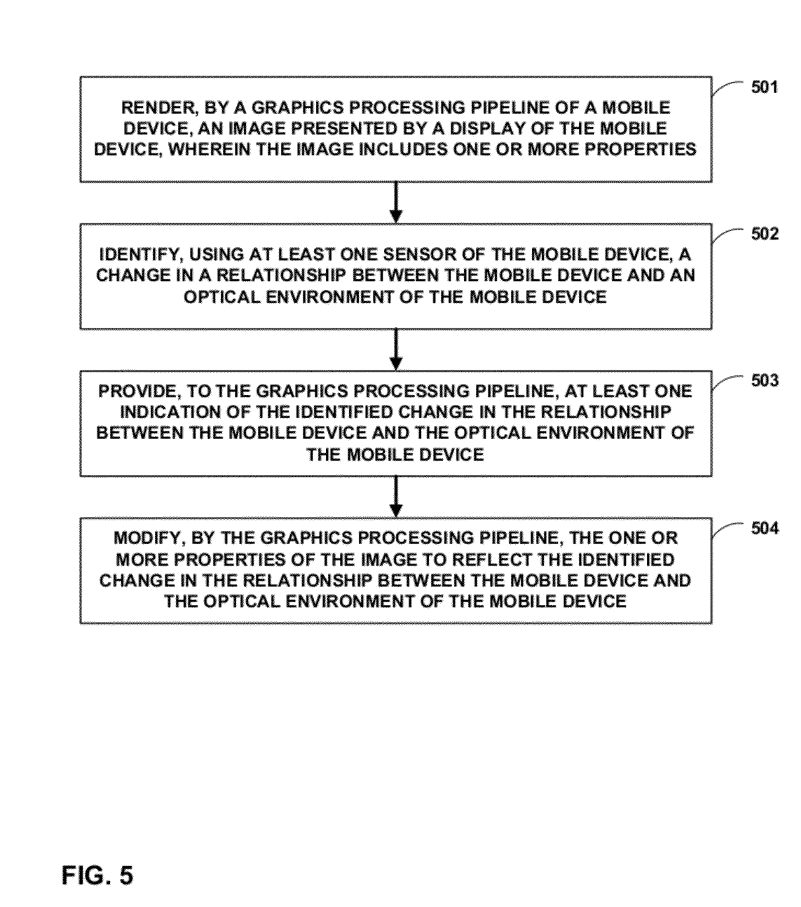

FIG. 5 is a flow chart diagram that illustrates one example of a method of operating a device consistent with the techniques of this disclosure. The method includes rendering, by a graphics processing pipeline of a mobile device (e.g., device 101, device 201, device 301, device 401), an image (e.g., image 110A) presented by a display 102 of the mobile device, wherein the image includes one or more properties (e.g., 112A) (501). The method further includes identifying, using at least one sensor (e.g., 220) of the mobile device, a change in a relationship between the mobile device and an optical environment of the mobile device (502). The method further includes providing, to the graphics processing pipeline, at least one indication of the identified change in the relationship between the mobile device and the optical environment of the mobile device (503). The method further includes modifying, by the graphics processing pipeline, the one or more properties (e.g., 112B) of the image (e.g., 110B) to reflect the identified change in the relationship between the mobile device and the optical environment of the mobile device (504).

Various embodiments of the disclosure have been described. These and other embodiments are within the scope of the following claims.

1. A method, comprising:
rendering, by a graphics processing pipeline of a mobile device, an image presented by a display of the mobile device, wherein the image includes one or more properties;
identifying, using at least one sensor of the mobile device, a characteristic of a relationship between the mobile device and an optical environment of the mobile device wherein the optical environment of the mobile device comprises detectable light proximal to the mobile device;
providing, to the graphics processing pipeline, at least one indication of the characteristic of the relationship between the mobile device and the optical environment; and
modifying, by the graphics processing pipeline, the one or more properties of the image presented on the display to reflect the characteristic of the relationship between the mobile device and the optical environment of the mobile device.

2. The method of claim 1, wherein identifying the characteristic of the relationship between the mobile device and the optical environment of the mobile device includes identifying a level of illumination of the optical environment of the mobile device.

3. The method of claim 1, wherein identifying the characteristic of the relationship between the mobile device and the optical environment of the mobile device includes identifying a position of the mobile device with respect to the optical environment of the mobile device.

4. The method of claim 1, wherein identifying the characteristic of the relationship between the mobile device and the optical environment of the mobile device includes identifying an orientation of the mobile device with respect to the optical environment of the mobile device.

5. The method of claim 1, wherein identifying the characteristic of the relationship between the mobile device and the optical environment of the mobile device includes identifying a movement of the mobile device with respect to the optical environment of the mobile device.

6. The method of claim 1, wherein identifying the characteristic of the relationship between the mobile device and the optical environment of the mobile device includes identifying a color of light of the optical environment of the mobile device.

7. The method of claim 1, wherein identifying the characteristic of the relationship between the mobile device and the optical environment of the mobile device includes identifying reflection in the optical environment of the mobile device.

8. The method of claim 1, wherein modifying the one or more properties of the image to reflect the at least one characteristic comprises modifying a level of illumination of the image.

9. The method of claim 1, wherein modifying the one or more properties of the image to reflect the at least one characteristic comprises modifying a shadowing or shading of the image.

10. The method of claim 1, wherein modifying the one or more properties of the image to reflect the at least one characteristic comprises modifying an orientation of the image.

11. The method of claim 1, wherein modifying the one or more properties of the image to reflect the at least one characteristic comprises modifying a position of the image.

12. The method of claim 1, wherein modifying the one or more properties of the image to reflect the at least one characteristic comprises modifying a movement of the image.

13. The method of claim 1, wherein modifying the one or more properties of the image to reflect the at least one characteristic comprises modifying a color of the image.

14. The method of claim 1, wherein modifying the one or more properties of the image to reflect the at least one characteristic comprises modifying a reflectance of the image.

15. The method of claim 1, wherein the at least one sensor of the device includes one or more sensors selected from a group consisting of:
a image capture device;
an ambient light sensor;
a gyroscope;
an accelerometer; and
a global positioning system (GPS) unit.

16. The method of claim 1, wherein identifying the at least one characteristic of the relationship between the mobile device and the optical environment of the mobile device includes:
capturing, using at least one image capture device of the mobile device, at least one image; and
determining, based on processing of the image, the at least one characteristic.

17. The method of claim 16, wherein determining the at least one characteristic comprises:
determining a relative position or orientation of the mobile device with respect to at least one light source.

18. The method of claim 16, wherein identifying the at least one characteristic of the relationship between the mobile device and the optical environment of the mobile device comprises:
comparing two or more captured images to determine one or more changes in the at least one characteristic of the relationship between the mobile device and the optical environment of the mobile device.

19. The method of claim 1, wherein modifying the one or more properties of the image to reflect the at least one characteristic comprises:
modifying one or more properties that correspond to the at least one characteristic.

20. The method of claim 1, further comprising:
using the at least one characteristic to receive user input; and
modifying one or more operations of the mobile device based upon the user input.

21. A mobile device, comprising:
a graphics processing pipeline configured to render an image at a display of the mobile device, wherein the image includes one or more properties;
a sensor processing module configured to receive, from at least one sensor communicatively coupled to the mobile device, a characteristic of a relationship between the mobile device and an optical environment of the mobile device and provide, to the graphics processing pipeline, at least one indication of the at least one characteristic of the relationship between the mobile device and the optical environment of the mobile device, wherein the optical environment of the mobile device comprises detectable light proximal to the mobile device; and
means for modifying the one or more properties of the image to reflect the at least one characteristic of the relationship between the of the mobile device and the optical environment of the of the mobile device.

22. An article of manufacture comprising a computer-readable medium that stores instructions configured to cause a mobile device to:
render, by a graphics processing pipeline of the mobile device, an image presented by a display of the mobile device, wherein the image includes one or more properties;
identify, using at least one sensor of the mobile device, a characteristic of a relationship between the mobile device and an optical environment of the mobile device wherein the optical environment of the mobile device comprises detectable light proximal to the mobile device;
provide, to the graphics processing pipeline, at least one indication of the at least one characteristic of the relationship between the mobile device and the optical environment; and
modify, by the graphics processing pipeline, the one or more properties of the image to reflect the at least one characteristic of the relationship between the mobile device and the optical environment of the mobile device.
